(19) United States
(12) Patent Application Publication
(10) Pub. No.: US 2025/0043390 A1
(43) Pub. Date: Feb. 6, 2025

(54) METHOD FOR PRODUCING BATTERY MATERIAL

(71) Applicant: Prime Planet Energy & Solutions, Inc., Tokyo (JP)

(72) Inventor: Shinya SUZUKI, Kobe-shi (JP)

(21) Appl. No.: 18/788,127

(22) Filed: Jul. 30, 2024

(30) Foreign Application Priority Data
Aug. 3, 2023 (JP) 2023-126810

(51) Int. Cl. C22B 3/00; C22B 3/22; C22B 7/00; H01M 10/54

(52) U.S. Cl. CPC C22B 23/0446; C22B 3/22; C22B 7/006; H01M 10/54

(57) ABSTRACT

An object of the present disclosure is to provide a method for producing a battery material with an improved recovery rate of valuable metals. The method for producing a battery material disclosed herein comprises: a preparation step of preparing a recovery target comprising at least one of Ni and Co; an acid leaching step of immersing the recovery target in an acid liquid to obtain an acid leaching liquid; a neutralization precipitation step of mixing the acid leaching liquid and a neutralizer to obtain a precipitate; a solid-liquid separation step of separating the precipitate into solid and liquid; and an ammonia leaching step of immersing the separated precipitate in an ammonia solution containing ammonium ions to obtain an ammonia leaching liquid containing at least one of the Ni and the Co.

### CROSS REFERENCE TO RELATED APPLICATIONS

This application claims the benefit of priority to Japanese Patent Application No. 2023-126810 filed on Aug. 3, 2023. The entire contents of this application are hereby incorporated herein by reference.

### BACKGROUND OF THE DISCLOSURE

### 1. Field

The technology disclosed herein relates to a method for producing a battery material.

### 2. Background

Lithium ion secondary batteries are widely used in various fields. Various materials containing valuable metals, such as Ni and Co, are used for such lithium ion secondary batteries. For example, lithium transition metal composite oxides, such as lithium nickel composite oxides, lithium cobalt composite oxides, lithium nickel cobalt composite oxides, and lithium nickel cobalt manganese composite oxides, are used for positive electrode active materials. Further, aluminum and the like are used for positive electrode cores.

In recent years, recovery technology has been developed to recover valuable metals from used batteries and process scraps and reuse them as battery materials. For example, Japanese Patent Application Laid-Open No. 2020-164971 discloses an example of positive electrode plate recovery technology. In the recovery method described in Japanese Patent Application Laid-Open No. 2020-164971, a recovery target (lithium ion battery scrap) is leached with acid, the leached liquid obtained by leaching is neutralized to remove at least part of aluminum ions from the leached liquid to obtain a neutralized liquid, and the neutralized liquid is subjected to solvent extraction to extract the remaining aluminum ions from the neutralized liquid. It is disclosed that as a result of this procedure, cobalt (Co) and/or nickel (Ni) can be recovered from the extraction residue from which aluminum has been removed.

### SUMMARY

As disclosed in Japanese Patent Application Laid-Open No. 2020-164971 mentioned above, in the conventional positive electrode plate recovery technology, an acid leaching liquid containing a recovery target is neutralized to thereby deposit and remove at least part of aluminum ions (aluminum) as a precipitate. Part of such a precipitate may contain valuable metals (Ni and/or Co). Therefore, with the conventional positive electrode plate recovery technology, such valuable metals may be removed from the recovery target, and the valuable metals cannot be sufficiently recovered.

The present disclosure was made in view of such circumstances, and an object thereof is to provide a method for producing a battery material with an improved recovery rate of valuable metals.

In order to address the above object, a method for producing a battery material with the following configuration (hereinafter also referred to simply as “the production method”) is provided.

The method for producing a battery material disclosed herein comprises: a preparation step of preparing a recovery target comprising at least one of Ni and Co; an acid leaching step of immersing the recovery target in an acid liquid to obtain an acid leaching liquid; a neutralization precipitation step of mixing the acid leaching liquid and a neutralizer to obtain a precipitate; a solid-liquid separation step of separating the precipitate into solid and liquid; and an ammonia leaching step of immersing the separated precipitate in an ammonia solution containing ammonium ions to obtain an ammonia leaching liquid containing at least one of the Ni and the Co.

In the production method with the above configuration, the precipitate obtained in the neutralization precipitation step is leached with ammonia, whereby Ni and/or Co in the precipitate can be separated and dissolved in an ammonia solution. This can improve the recovery rate of valuable metals from the recovery target.

### BRIEF DESCRIPTION OF THE DRAWINGS

FIG. 1 is a longitudinal cross-sectional view schematically showing the internal structure of a lithium ion secondary battery;

FIG. 2 is a perspective view schematically showing an electrode body of the lithium ion secondary battery shown in FIG. 1;

FIG. 3 is a flowchart explaining a method for producing a battery material according to one embodiment; and

FIG. 4 is a flowchart explaining in detail a solvent extraction step in FIG. 3.

### DETAILED DESCRIPTION OF THE PREFERRED EMBODIMENTS

The embodiment of the technology disclosed herein will be explained below with reference to the drawings. Matters other than those specifically mentioned in the present specification that are necessary for implementing the technology disclosed herein can be understood as design matters for a person skilled in the art based on conventional technology in this field. The technology disclosed herein can be implemented based on the contents disclosed in the present specification and common technical knowledge in this field. In addition, the expression “A to B” indicating a range in the present specification includes the meaning of “A or more and B or less” as well as “preferably more than A” and “preferably less than B.”

### 1. Recovery Target

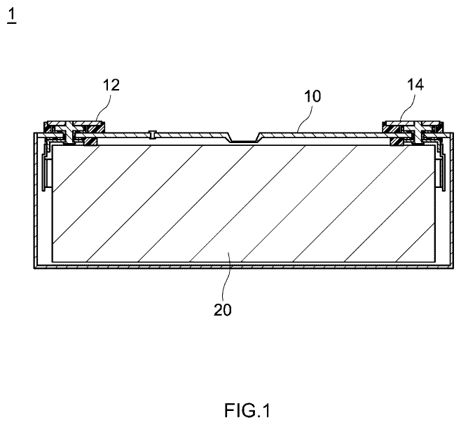

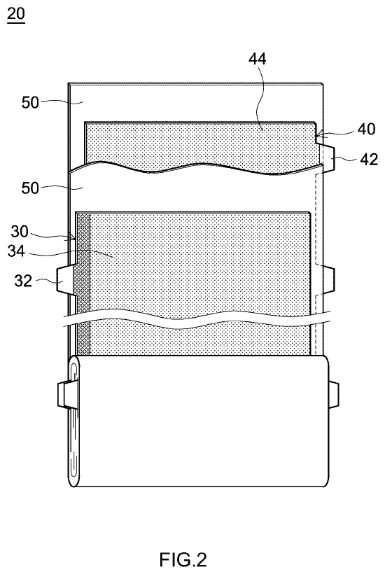

In the method for producing a battery material according to the present embodiment, valuable metals, such as Ni and Co, are recovered from a predetermined recovery target, thereby producing battery materials (typically a positive electrode active material, a positive electrode active material precursor, and a positive electrode active material of a lithium ion secondary battery). Examples of the recovery target include used lithium ion secondary batteries. Such a lithium ion secondary battery will be described in detail below. FIG. 1 is a longitudinal cross-sectional view schematically showing the internal structure of a lithium ion secondary battery. FIG. 2 is a perspective view schematically showing an electrode body of the lithium ion secondary battery shown in FIG. 1.

As shown in FIG. 1, the lithium ion secondary battery 1 comprises a case 10, an electrode body 20, and an electrolyte (not shown).

### (1) Case

The case 10 is a box-shaped container. The electrode body 20 and the electrolyte are housed within the case 10. For example, a metal material with a specific strength (e.g. aluminum (Al) etc.) is used for the case 10. Further, a positive electrode terminal 12 and a negative electrode terminal 14 are attached to the case 10. The positive electrode terminal 12 and the negative electrode terminal 14 are connected to the electrode body 20 within the case 10. Specifically, the positive electrode terminal 12 is connected to a positive electrode plate 30 (see FIG. 2) of the electrode body 20. Aluminum (Al) or the like is used for the positive electrode terminal 12. On the other hand, the negative electrode terminal 14 is connected to a negative electrode plate 40 of the electrode body 20. Copper (Cu) or the like is used for the negative electrode terminal 14.

### (2) Electrode Body

The electrode body 20 is a power generation element of the lithium ion secondary battery 1. As shown in FIG. 2, the electrode body 20 comprises the positive electrode plate 30, the negative electrode plate 40, and a separator 50. The electrode body 20 shown in FIG. 2 is a winding electrode body. The winding electrode body is produced by laminating the positive electrode plate 30, the negative electrode plate 40, and the separator 50 to form a long strip laminate, and winding the laminate. However, the structure of the electrode body 20 is not particularly limited, and may be any of other conventionally known structures (e.g. a laminated electrode body etc.).

The positive electrode plate 30 comprises a positive electrode core 32, which is conductive metal foil, and a positive electrode active material layer 34 applied to the surface of the positive electrode core 32. Aluminum (Al) or the like is used for the positive electrode core 32. Further, the positive electrode active material layer 34 is a composite material layer containing a positive electrode active material, a conductive material, a binder, and the like. The positive electrode active material is a lithium transition metal composite oxide containing at least one of nickel (Ni) and cobalt (Co). Examples of such lithium transition metal composite oxides include lithium nickel composite oxides, lithium cobalt composite oxides, lithium nickel manganese composite oxides, lithium manganese cobalt composite oxides, lithium nickel cobalt composite oxides, lithium nickel manganese cobalt composite oxides, and the like. With the production method according to the present embodiment, Ni and/or Co can be efficiently recovered from a recovery target containing such a lithium transition metal composite oxide. Examples of the conductive material include carbon materials, such as acetylene black and graphite. Examples of the binder include resin materials, such as polyvinylidene fluoride (PVDF).

On the other hand, the negative electrode plate 40 comprises a negative electrode core 42, which is conductive metal foil, and a negative electrode active material layer 44 applied to the surface of the negative electrode core 42. Copper (Cu) or the like is used for the negative electrode core 42. Further, the negative electrode active material layer 44 is a composite material layer containing a negative electrode active material, a binder, a thickener, and the like. Examples of the negative electrode active material include carbon materials, such as graphite, hard carbon, and soft carbon. Other examples of the negative electrode active material include lithium titanate (LTO), silicon carbide, composites containing carbon and silicon, silicon oxide (SiOx), and the like. Examples of the binder include resin materials, such as styrene butadiene rubber (SBR). Examples of the thickener include resin materials, such as carboxymethylcellulose (CMC).

The separator 50 is an insulating sheet disposed between the positive electrode plate 30 and the negative electrode plate 40. For example, a resin material, such as polyethylene (PE), polypropylene (PP), polyester, cellulose, or polyamide, is used for the separator 50. In addition, a heat-resistant layer containing an inorganic filler may be formed on the surface of the separator 50. Examples of such inorganic fillers include inorganic oxides, such as aluminum oxide, magnesium oxide, silicon oxide, and titanium oxide; nitrides, such as aluminum nitride and silicon nitride; metal hydroxides, such as calcium hydroxide, magnesium hydroxide, and aluminum hydroxide; clay minerals, such as mica, talc, boehmite, zeolite, apatite, and kaolin; and the like.

### (3) Electrolyte

An electrolyte is present between the positive electrode plate 30 and the negative electrode plate 40. This allows charge carriers (Li ions) to move between the positive electrode plate 30 and the negative electrode plate 40. Examples of the electrolyte include non-aqueous electrolytes, gel-like electrolytes, and the like. As the electrolyte, any electrolyte that can be used for lithium ion secondary batteries can be used without any particular limitation, and the technology disclosed herein is not limited thereby.

The lithium ion secondary battery 1 is described above as an example of the recovery target in the production method according to the present embodiment. However, the production method disclosed herein is not limited to the method with the above configuration that uses the lithium ion secondary battery 1 as a recovery target. For example, at the production site of lithium ion secondary batteries, part of a positive electrode plate may be cut when an electrode body is produced. The cut part of the positive electrode plate (process scrap) may also contain Ni and Co, and thus can be served as the recovery target of the production method disclosed herein. Further, at the production site of lithium ion secondary batteries, some defects may occur in the produced electrode body, making it unusable for products. Such an electrode body may also contain Ni and Co, and thus can be served as the recovery target. That is, the recovery target of the production method disclosed herein may contain at least one of Ni and Co as a valuable metal, and is not particularly limited to a specific structure.

### 2. Method for Producing Battery Material

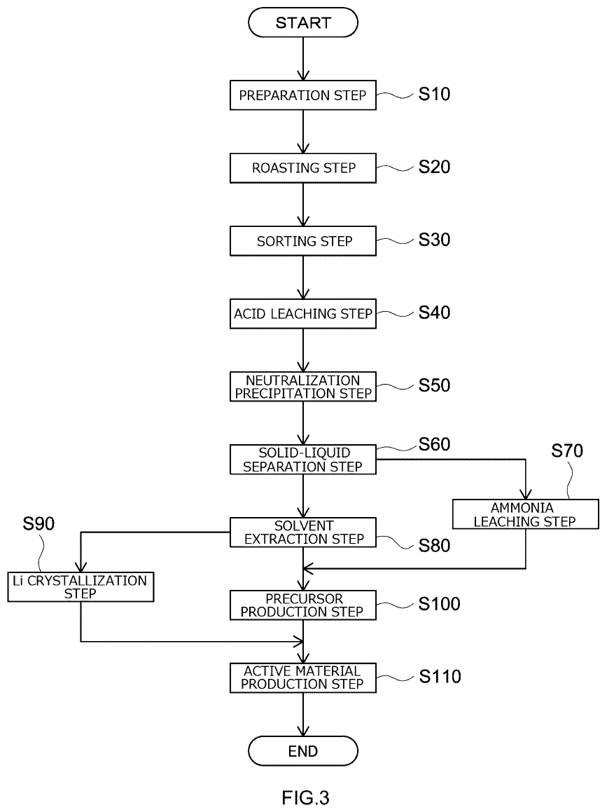

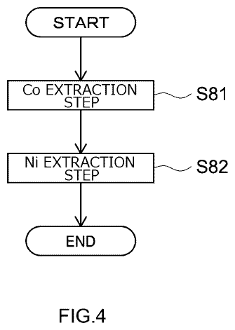

The method for producing a battery material according to the present embodiment will be described below. FIG. 3 is a flowchart explaining the production method according to the present embodiment. FIG. 4 is a flowchart explaining in detail a solvent extraction step in FIG. 3.

As shown in FIG. 3, the method for producing a battery material according to the present embodiment comprises a preparation step S10, an acid leaching step S40, a neutralization precipitation step S50, a solid-liquid separation step S60, and an ammonia leaching step S70. The method for producing a battery material disclosed herein may further comprise a roasting step S20, a sorting step S30, a solvent extraction step S80, a Li crystallization step S90, a precursor production step S100, and an active material production step S110. In addition, the production method disclosed herein may further comprise other steps at any stage, and other production processes may be the same as conventional ones. Each step will be described below.

### (1) Preparation Step S10

In the preparation step S10, a recovery target containing at least one of Ni and Co is prepared. As described above, it is sufficient for the “recovery target” in the technology disclosed herein to contain at least one of Ni and Co. That is, the recovery target is not limited to completed lithium ion secondary batteries, but includes process scraps and defective parts (e.g. electrode bodies etc.). Since the details of the recovery target have already been explained above, duplicate description is omitted.

### (2) Roasting Step S20

In the roasting step S20, the recovery target is heated at a predetermined temperature. This allows liquid components (electrolyte etc.) in the recovery target to be removed and resin components (binder, separator, etc.) to be carbonized. When a charged lithium ion secondary battery 1 is used as the recovery target, the function as a battery can be stopped by performing the roasting step S20. Due to this, the subsequent steps can be performed safely. As for the method of the roasting step S20, the technology used in conventional recovery technology can be used without any particular limitation, and it does not characterize the technology disclosed herein; thus, detailed explanation is omitted.

The roasting step S20 is not essential and can be appropriately omitted, as necessary. For example, a recovery target that does not need to remove liquid components and does not need to stop the function as a battery, such as process scraps of the positive electrode plate 30, may be prepared in the preparation step S10. In this case, valuable metals can be efficiently recovered even if the roasting step S20 is omitted.

### (3) Sorting Step S30

In the sorting step S30, each part contained in the recovery target is sorted. The method of the sorting step S30 can be a conventionally known method. For example, sorting by sieving, visual inspection, etc. can be performed. For example, when the recovery target is process scraps of the positive electrode plate 30, the positive electrode core 32 may be sorted from the process scraps and removed from the recovery target. When the recovery target is the electrode body 20, the negative electrode plate 40 may also be removed from the recovery target in addition to the positive electrode core 32. Further, when the recovery target is the lithium ion secondary battery 1, the case 10 may also be removed from the recovery target in addition to the positive electrode core 32 and the negative electrode plate 40. This can reduce the content of other metals (e.g., Al, Cu, etc.) in the recovery target, which can contribute to the improvement of the recovery efficiency of valuable metals (Co and Ni).

In the sorting step S30, crushing may be performed on the recovery target, as needed. This can improve the efficiency of sorting each part. For example, when the recovery target is the lithium ion secondary battery 1, the case 10 and the electrode body 20 may be crushed. As a result, the case 10, the positive electrode core 32, and the negative electrode plate 40 can be easily removed from the recovery target.

The sorting step S30 is not intended to completely remove other metal components, such as Al and Cu, from the recovery target. Although the details will be described later, even if other metal components remain in the recovery target, valuable metals (Ni and/or Co) can be sufficiently separated from the other metal components in the subsequent steps (e.g., the neutralization precipitation step S50 and the ammonia leaching step S70). That is, the sorting step S30 can be appropriately omitted, as needed. For example, in the case of a recovery target with a low content of other metal components (process scraps of the positive electrode plate 30 etc.), valuable metals can be efficiently recovered even if the sorting step S30 is omitted.

### (4) Acid Leaching Step S40

In the acid leaching step S40, the recovery target after the preparation step S10 (or the roasting step S20 or the sorting step S30) is immersed in an acid liquid. As a result, valuable metals (Ni and/or Co) in the recovery target are dissolved in the acid liquid. In the acid leaching step S40, other metal materials (Al etc.) other than valuable metals may be dissolved in the acid liquid. That is, the acid liquid after the acid leaching step S40 (hereinafter also referred to as “the acid leaching liquid”) may contain, for example, Li, Al, Cu, Co, Ni, and Mn. As the procedure of acid leaching, conventionally known procedures can be employed without any particular limitation. For example, the pH of the acid liquid used in the acid leaching step S40 is preferably −1.5 to 1.5 (more preferably −0.5 to 0.5). Due to this, the metal components in the recovery target can be preferably dissolved. Specific examples of the acid liquid include inorganic acids, such as sulfuric acid, nitric acid, hydrochloric acid, and phosphoric acid; and organic acids, such as citric acid, ascorbic acid, oxalic acid, and acetic acid. Further, in the acid leaching step S40, a reducing agent, such as hydrogen peroxide, can be placed in addition to the acid liquid. This can improve the dissolution rate of the recovery target in the acid liquid, and can shorten the acid leaching step S40. In addition, in the acid leaching step S40, the acid leaching liquid after acid leaching is preferably subjected to filtration treatment. This can efficiently remove undissolved components (carbon components etc.). The temperature of the acid liquid is preferably 50° C. or higher (more preferably 55° C. or higher, and particularly preferably 60° C. or higher). This can shorten the acid leaching step S40. The upper limit of the temperature of the acid liquid is not particularly limited, and may be 90° C. or lower, 85° C. or lower, or 80° C. or lower. The concentration of Ni and Co (sum of Ni and Co) in the acid leaching liquid after the acid leaching step S40 is not particularly limited; however, a higher concentration is more preferred in terms of productivity. Therefore, the concentration of Ni and Co (sum of Ni and Co) in the acid leaching liquid is preferably 1.0 mol/L to 2.0 mol/L. The concentration of Ni and Co (sum of Ni and Co) in the acid leaching liquid can be determined by ICP analysis.

### (5) Neutralization Precipitation Step S50

In the neutralization precipitation step S50, a neutralizer is added to the acid leaching liquid obtained in the acid leaching step S40 to increase the pH of the acid leaching liquid. Due to this, Al contained in the acid leaching liquid is deposited and precipitated as a hydroxide (Al(OH)₃). As a result, a metal solution in which Al has been roughly removed from the acid leaching liquid containing Li, Al, Cu, Co, Ni, Mn, and the like can be obtained. As the neutralizer used in the neutralization precipitation step S50, an alkaline solution with a pH of 11 to 15 (preferably a pH of 12 to 14) can be used. Specific examples of the neutralizer include an aqueous sodium hydroxide solution, calcium hydroxide, and the like. Of these, an aqueous sodium hydroxide solution is preferably contained as the neutralizer. The concentration of the neutralizer is not particularly limited; however, a higher concentration is more preferred in terms of productivity. Therefore, the concentration of the neutralizer is preferably 10 to 30 wt %.

The pH adjusted in the neutralization precipitation step S50 is preferably 5.0 or more, preferably 5.1 or more, and more preferably 5.6 or more. If the pH of the acid leaching liquid is low (typically a pH of less than 4.5), Al in the acid leaching liquid is less likely to form a hydroxide. In other words, it is difficult to separate Al from the acid leaching liquid. As the pH of the acid leaching liquid increases, Al in the acid leaching liquid can be deposited and precipitated as Al hydroxide. In other words, Al can be more suitably separated from the acid leaching liquid. On the other hand, the pH adjusted in the neutralization precipitation step S50 is not particularly limited; however, as the pH increases, part of Ni and Co in the acid leaching liquid may also form hydroxides, which may be precipitated in the metal solution. Therefore, the pH adjusted in the neutralization precipitation step S50 is preferably 6.5 or less, and more preferably 6.2 or less. Although the details will be described later, even when part of Ni and Co is precipitated, Ni and Co can be separated from the precipitate in the subsequent step (ammonia leaching step S70).

### (6) Solid-Liquid Separation Step S60

In the solid-liquid separation step S60, the metal solution and precipitate after the neutralization precipitation step S50 are separated into liquid and solid. As a result, the precipitate and the metal solution containing valuable metals (Ni and/or Co) and other metal components can be separately obtained. Since a conventionally known method can be used as the method of solid-liquid separation, detailed explanation is omitted here. The metal solution obtained in the solid-liquid separation step S60 is not particularly limited to this; however, the metal components contained in the metal solution are subjected to each recovery step (solvent extraction step S80) described later, whereby each metal component contained in the metal solution can be recovered.

As described above, in the neutralization precipitation step S50, while Al in the acid leaching liquid can be precipitated as a hydroxide, part of Ni and/or Co also forms hydroxides, and these hydroxides can also be precipitated in the metal solution, as with the hydroxide of Al. That is, the precipitate obtained in the solid-liquid separation step S60 may contain valuable metals (Ni and/or Co) as hydroxides. In order to recover valuable metals (Ni and/or Co) from such a precipitate, it is possible, for example, to dissolve the precipitate by returning it to the acid leaching liquid obtained in the acid leaching step S40. However, in this case, Al is accumulated in the acid leaching liquid (in other words, the Al concentration in the acid leaching liquid increases), which on the contrary leads to a decrease in the yield of valuable metals (Ni and/or Co), which is not preferable. As shown in FIG. 3, the present embodiment is characterized by further comprising an ammonia leaching step S70 in addition to the neutralization precipitation step S50 and the solid-liquid separation step S60. This can significantly improve the recovery efficiency of valuable metals (Ni and/or Co). This will be described in detail below.

### (7) Ammonia Leaching Step S70

In the ammonia leaching step S70, the precipitate deposited in the neutralization precipitation step S50 and obtained by solid-liquid separation in the solid-liquid separation step S60 is immersed in an ammonia solution. As a result, Ni and/or Co in the precipitate can be separated, and an ammonia solution in which Ni and/or Co are dissolved (hereinafter referred to as “the ammonia leaching liquid”) can be obtained. In detail, hydroxides of Ni and Co typically form ammine complexes in the ammonia solution. The ammine complexes are dissolved in the ammonia solution. On the other hand, Al (and Al hydroxide) does not form ammine complexes in the ammonia solution and typically remains in the form of an Al hydroxide (Al(OH)₃) as a residue (precipitate). As a result, valuable metals (Ni and/or Co) in the precipitate can be selectively recovered. The “ammonia solution” in the present specification refers to an aqueous solution containing ammonium ions in water as a solvent.

The ammonia solution may be, for example, purchased commercially (ammonia water), or a solution containing at least a water-containing solvent and an ammonia salt dissolved therein may be used. As the ammonia salt used in the ammonia solution, for example, ammonium hydroxide (NH₄OH), ammonium sulfate ((NH₄)₂SO₄), ammonium carbonate ((NH₄)₂CO₃), ammonium bicarbonate (NH₄HCO₃), ammonium chloride (NH₄Cl), ammonium fluoride (NH₄F), or the like can be appropriately used. These compounds may be used singly or in combination of two or more.

In some preferred embodiments, it is preferable that the ammonia solution contains at least one member selected from the group consisting of ammonium sulfate, ammonium chloride, and ammonium acetate. These have a role as a so-called pH buffer material for the ammonia solution. In detail, these can reduce the pH of the ammonia solution. Because the pH of the ammonia solution is reduced, Ni and Co suitably form ammine complexes while suppressing the dissolution of Al in the ammonia solution, whereby Ni and Co can be suitably selectively dissolved in the ammonia solution. Furthermore, since the configuration described above can increase the ammonia concentration in the ammonia solution, Ni and Co can suitably form ammine complexes, which can be suitably dissolved in the ammonia solution. Therefore, Ni and Co in the precipitate can be suitably selectively leached (recovered) into the ammonia solution.

In the ammonia leaching step S70, it is preferable to perform ammonia leaching after adjusting the pH of the ammonia solution to 9.0 to 11.5, and more preferably 9.5 to 10.0. As the pH of the ammonia solution decreases, Ni and Co can more suitably form ammonia complexes, so that these valuable metals (Ni and/or Co) can be preferably recovered. If the pH is too high (typically above a pH of 11.5), part of Al in the precipitate forms a hydroxide complex ([Al(OH)₄]⁻) and begins to dissolve in the ammonia solution.

In the ammonia leaching step S70, the ammonia concentration in the ammonia solution is preferably 10 wt % or more, and more preferably 20 wt % or more. As the ammonia concentration increases, Ni and/or Co can more suitably form ammonia complexes, so that valuable metals (Ni and/or Co) can be recovered more efficiently from the precipitate. On the other hand, in terms of the high volatility of ammonia, the upper limit of the ammonia concentration in the ammonia solution is not limited thereto, but is, for example, 35 wt % or less, and preferably 30 wt % or less.

Since the ammonium ions in the ammonia solution are also used to form ammine complexes by Ni and/or Co, the pH and free ammonia concentration decrease compared to the initial ammonia solution (hereinafter also referred to as “the initial solution”) as the ammonia leaching step progresses. Accordingly, an additional ammonia solution may be added in the middle of the ammonia leaching step S70. As a result, the pH and ammonia concentration in the ammonia solution can be maintained within a suitable range, and valuable metals (Ni and/or Co) in the precipitate can be separated more efficiently. The pH of the additional ammonia solution may be the same as or higher than the pH of the initial solution. The ammonia concentration of the additional ammonia solution may be the same as or higher than the ammonia concentration of the initial solution. Further, the composition of the additional ammonia solution may be the same as or different from that of the initial solution.

The temperature of the mixed liquid in the ammonia leaching step S70 is not particularly limited, but is preferably 25° C. or higher, more preferably 40° C. or higher, and particularly preferably 60° C. or higher. This can shorten the time of the ammonia leaching step S70. On the other hand, the upper limit of the temperature of the mixed liquid is not particularly limited, but is preferably 100° C. or lower, more preferably 90° C. or lower, and particularly preferably 80° C. or lower.

The leaching time in the ammonia leaching step S70 is not particularly limited because it can vary depending on, for example, the ammonia concentration in the reaction liquid, the reaction temperature, and the like; however, the leaching time is generally preferably 0.5 hours or more, more preferably 1 hour or more, and particularly preferably 2 hours or more. On the other hand, in terms of productivity, the leaching time is generally preferably 8 hours or less, more preferably 6 hours or less, and particularly preferably 4 hours or less. Although it is not particularly limited, it is preferable to perform the ammonia leaching step S70 while stirring the ammonia solution. This can increase the contact area between the precipitate and the ammonia solution, so that valuable metals (Ni and/or Co) can be efficiently dissolved in the ammonia solution. Therefore, the leaching time can be shortened.

After the ammonia leaching step S70, the ammonia leaching liquid and the residue are separated into liquid and solid. As a result, an ammonia leaching liquid in which Ni and/or Co are dissolved in the ammonia solution can be obtained. The application of the ammonia leaching liquid is not particularly limited, but can be suitably used, for example, as an alkaline solution in a precursor production step S100 described later. In this case, the ammonia leaching liquid can be directly used as the alkaline solution without any steps such as washing. That is, there is no loss of valuable metals due to washing or re-extraction. Further, valuable metals (Ni and/or Co) in the ammonia leaching liquid can also be used as a positive electrode active material precursor. Therefore, the recovery rate of valuable metals (Ni and/or Co) contained in the recovery target can be improved.

As described above, in the production method disclosed herein, the precipitate obtained in the neutralization precipitation step can be leached into an ammonia solution, whereby valuable metals (Ni and/or Co) in the precipitate can be recovered. Conventionally, an acid leaching liquid after an acid leaching step is subjected to a neutralization precipitation step to separate valuable metals (Ni and/or Co). In this case, part of valuable metals (Ni and/or Co) may also be precipitated as precipitates together with Al, resulting in loss of the valuable metals, and there was a problem that in order to reduce this loss, the pH could not be increased sufficiently in the neutralization precipitation step in order to suppress the precipitation of the valuable metals, and Al could not be sufficiently separated from the acid leaching liquid. On the other hand, in the production method disclosed herein, valuable metals (Ni and/or Co) can be separated from the precipitate by the ammonia leaching step, and the recovery rate of such valuable metals can be improved.

### (8) Solvent Extraction Step S80

In the solvent extraction step S80, each metal component (Ni and/or Co) is extracted from the metal solution using a solvent extraction method. Further, in the solvent extraction step S80, other metal components (Al etc.) remaining in the metal solution can also be separated. Specifically, the solvent extraction step S80 in the present embodiment comprises a Co extraction step S81 and a Ni extraction step S82, as shown in FIG. 4. Due to these steps, a Co solution and a Ni solution can be each prepared. However, in the solvent extraction step S80, steps can be appropriately added, changed, or deleted depending on the metal components contained in the metal solution. This will be described in detail below.

### (8-1) Co Extraction Step S81

In the Co extraction step S81, an organic solvent that has high extractability for Co and low extractability for Li, Al, Cu, and Ni (first extraction liquid) is added to the metal solution. As a result, Co is separated from the metal solution, and a Co solution in which Co is dissolved in the first extraction liquid can be obtained. Specific examples of the first extraction liquid include phosphonic acid esters, such as 2-ethylhexyl 2-ethylhexyl phosphonate (PC-88A). The first extraction liquid may also be obtained by mixing and diluting these extractants. In the Co extraction step S81, the metal solution and the first extraction liquid are suspended by stirring. As a result, Co in the metal solution is dissolved in the first extraction liquid. Then, the resultant is allowed to stand until two liquids are separated, whereby a Co solution in which Co is dissolved in the first extraction liquid, and a metal solution from which Co has been removed can be obtained.

In the Co extraction step S81, the Co solution after extraction (first extraction liquid containing Co) may be subjected to back extraction treatment. In the back extraction treatment, first, the Co solution (organic phase) and an acidic aqueous solution are stirred and mixed using a mixer or the like. Then, the resultant is allowed to stand until two liquids are separated. As a result, an aqueous Co solution can be obtained. Examples of the acidic aqueous solution used in the back extraction treatment include sulfuric acid, hydrochloric acid, and the like (particularly sulfuric acid).

### (8-2) Ni Extraction Step S82

In the Ni extraction step S82, an organic solvent that has high extractability for Ni and low extractability for Li, Al, and Cu (second extraction liquid) is added to the metal solution. As a result, Ni is separated from the metal solution, and a Ni solution in which Ni is dissolved in the second extraction liquid can be obtained. Specific examples of the second extraction liquid include carboxylic acid-based extractants, such as neodecanoic acid and naphthenic acid. Further, the Ni solution after extraction (second extraction liquid containing Ni) may also be subjected to back extraction treatment. As a result, an aqueous Ni solution can be obtained. Since the procedure for the back extraction treatment has already been explained, duplicate description is omitted.

### (9) Li Crystallization Step S90

In the Li crystallization step S90, crystals of a Li compound are deposited from the metal solution after the solvent extraction step S80. In the Li crystallization step S90, conventionally known crystallization treatment can be employed without any particular limitation. For example, in the Li crystallization step S90, sodium carbonate may be added to the metal solution. As a result, crystals of lithium carbonate (Li₂CO₃) can be deposited. The Li compound produced in the Li crystallization step S90 is not limited to lithium carbonate. For example, as needed, lithium hydroxide (LiOH) may be produced as the Li compound. In the production of lithium hydroxide, first, lithium carbonate deposited from the metal solution is dissolved (or suspended) in a predetermined solvent. Then, calcium hydroxide is added to the solution. Thereafter, the solvent is removed by evaporation, as needed. As a result, crystals of lithium hydroxide can be deposited. However, the Li crystallization step S90 is not essential in the production method disclosed herein. For example, when the metal solution does not contain Li (in other words, when the recovery target does not contain Li), the Li crystallization step S90 can be omitted.

### (10) Precursor Production Step S100

In the precursor production step S100, a positive electrode active material precursor (metal composite hydroxide) is produced. In the precursor production step S100, a conventionally known method (e.g., a crystallization method) can be employed without any particular limitation. For example, an aqueous solution containing a metal element source (typically a water-soluble ion compound) is prepared. Next, the aqueous solution containing a metal element source prepared above and an alkaline solution (e.g., an ammonia solution) are mixed in a reaction tank, and the mixed liquid is stirred while adjusting its pH, thereby co-precipitating and crystallizing metal composite hydroxide particles in the reaction tank. In the present embodiment, the ammonia leaching liquid obtained in the ammonia leaching step S70 can be suitably used as the alkaline solution. In the ammonia leaching liquid, Ni and/or Co are contained in the ammonia solution. Accordingly, the ammonia leaching liquid can be directly used as the alkaline solution in the precursor production step S100 without the need for treatment, such as washing. Therefore, Co and Ni in the ammonia solution can also be crystallized as positive electrode active material precursors. That is, valuable metals (Ni and/or Co) recovered from the precipitate in the ammonia leaching step S70 can be efficiently used.

As described above, in the precursor production step S100, crystallization is performed while controlling the pH of the mixed liquid. At this time, an alkaline solution (a NH₃ aqueous solution, a NaOH water solution, etc.) for pH adjustment can be added dropwise into the reaction tank. The amounts of Ni and Co in the metal solution obtained in the ammonia leaching step S70 can be determined by ICP analysis. For this reason, depending on the composition of the target positive electrode active material, Ni, Co, or other metal components, such as Mn, may be added. Such metal components can be added in the form of metal sulfates, hydrates, or the like. Moreover, in this case, the various metal components obtained in the solvent extraction step S80 may be used as metal components.

### (11) Active Material Production Step S110

In the active material production step S110, the metal compound obtained in the precursor production step S100 and a Li compound (e.g., Li₂CO₃) are used to produce a battery material (positive electrode active material). For example, the positive electrode active material precursor (metal composite hydroxide) obtained in the precursor production step S100 and a Li compound are mixed, and the resulting mixture is fired. As a result, a positive electrode active material (lithium transition metal composite oxide) of a lithium ion secondary battery can be produced. As such a Li compound, the Li compound obtained in the Li crystallization step S90 may be used.

The method for producing a battery material according to the present embodiment is explained above. As described above, in the production method according to the present embodiment, an ammonia leaching step is performed to immerse the precipitate obtained in the neutralization precipitation step in an ammonia solution. As a result, Ni and/or Co contained in the precipitate are dissolved in the ammonia solution, and an ammonia leaching liquid containing Ni and/or Co can be obtained. Therefore, in the neutralization precipitation step, valuable metals (Ni and/or Co) precipitated as part of the precipitate can be suitably recovered (produced); in other words, the recovery rate of valuable metals can be improved. Further, the ammonia leaching liquid obtained by the production method disclosed herein can be directly used in the precursor production step S100, for example, without performing steps, such as washing. Due to this, valuable metals (Ni and/or Co) contained in the ammonia leaching liquid can be used as positive electrode active material precursors. Therefore, valuable metals (Ni and/or Co) can be efficiently recovered, and the recovery rate of such valuable metals can be significantly improved.

### 3. Other Embodiments

An embodiment of the technology disclosed herein is describe above. The technology disclosed herein is not limited to the embodiment described above, and includes other embodiments with various changed configurations. Other embodiments of the technology disclosed herein will be described below.

### (a) Change of Solvent Extraction Step

The specific processing procedure in the solvent extraction step S80 can be appropriately changed. For example, the solvent extraction step S80 in the embodiment described above comprises a Co extraction step and a Ni extraction step. Due to these steps, a Co solution and a Ni solution can be extracted separately. However, Ni and Co may be extracted at the same time in the solvent extraction step S80. This makes it possible to improve production efficiency by shortening the process.

In addition, the steps that can be included in the solvent extraction step S80 are not limited to the Co extraction step and Ni extraction step. For example, when the metal solution further contains manganese (Mn) as a metal component, the solvent extraction step S80 may further comprise a Mn extraction step of extracting Mn from the metal solution. The means of the Mn extraction step is not particularly limited, but can be performed by adding, to the metal solution, an organic solvent that has high extractability for Mn and low extractability for Li, Al, Cu, Co, and Ni (third extraction liquid). As the third extraction liquid, a phosphate-based extractant, an oxime-based extractant, or the like can be used. Specific examples of phosphate-based extractants include di-2-ethylhexyl phosphate (D2EHPA) and the like. Further, specific examples of oxime-based extractants include 2-hydroxy-5-nonylacetophenone oxime (LIX84), 5-dodecylsalicyaldoxime (LIX860), 5-nonylsalicyaldoxime (ACORGA M5640), and the like. The third extraction liquid may be obtained by mixing and diluting these extractants. Further, the Mn solution after extraction (third extraction liquid containing Mn) may also be subjected to back extraction treatment. Since the specific extraction method and back extraction treatment method may be the same as the Co extraction step S81 and Ni extraction step S82, the description is omitted here.

### (b) Omission of Solvent Extraction Step

According to the production method disclosed herein, the solvent extraction step S80 can be omitted. Specifically, in the technology disclosed herein, Al can be separated from the metal solution by the neutralization precipitation step S50, as described above. For this reason, a solution containing high purity of valuable metals (Ni and/or Co) can be obtained. Therefore, when using a recovery target that does not contain Cu, such as process scraps of the positive electrode plate 30, the mixed liquid of valuable metals (aqueous solution containing metal element sources) used in the precursor production step S100 can be obtained without performing the solvent extraction step S80.

On the other hand, when the metal solution contains Li, examples of the means for recovering Li include the following means. First, when the roasting step S20 is performed, a non-metallic chlorine compound (HCl etc.) is added to the recovery target, followed by roasting. As a result, Li in the recovery target reacts with the non-metallic chlorine compound to produce LiCl. Next, a water leaching step is performed to immerse the roasted recovery target in water. Since LiCl is a water-soluble compound, Li can be recovered simply by bringing the recovery target into contact with water. As a result, while recovering (producing) Li in the metal solution, a mixed liquid of valuable metals (aqueous solution containing metal element sources) to be used in the precursor production step S100 can be obtained without performing the solvent extraction step S80. That is, the explanation regarding the above embodiment is not intended to limit each step. In the production method disclosed herein, each step may be appropriately added, deleted, or changed, as needed.

### (c) Addition of Li Separation Step

Further, in some embodiments, the metal solution after the solvent extraction step S80 may be subjected to a Li separation step. The Li separation step is a step of further removing Cu and Al from the metal solution to prepare a high-concentration Li solution. Due to this, a highly pure Li compound can be obtained in the Li crystallization step S90. The means for preparing the Li solution is not particularly limited, and it is preferable to appropriately employ conventionally known means, such as a solvent extraction method and an ion exchange method. Only evaporation of the solvent may be performed in place of the Li concentration step. Even in this case, a high-concentration Li solution can be obtained.

### (d) Addition of Li Concentration Step

In addition, the metal solution after the Li separation step may be subjected to a Li concentration step. In the Li concentration step, the Li solution is heated to evaporate the solvent. This makes it possible to obtain a high-concentration Li solution, thereby improving crystallization efficiency in the Li crystallization step S90. The Li concentration step may also be performed on a metal solution that has not been subjected to the Li separation step. Even in this case, a high-concentration Li solution can be obtained.

### Test Examples

Test Examples relating to the technology disclosed herein will be described below. The contents of the Test Examples described below are not intended to limit the technology disclosed herein.

### Test Example 1: Consideration of pH During Neutralization Precipitation Step

### Example 1

### [Preparation of Sample]

In this test, a positive electrode plate was used as a recovery target, and the recovery target was subjected to the following steps. Specifically, the positive electrode plate used was one in which a positive electrode active material layer was applied to the surface of a positive electrode core (Al foil). The positive electrode active material used in this test was a lithium nickel cobalt manganese composite oxide (LiNi_{1/3}Co_{1/3}Mn_{1/3}O₂). The positive electrode plate was crushed and passed through a sieve with an opening of 500 μm, and the resulting powder was used as a test sample. When the powder of the test sample was analyzed by ICP, the mass ratio of Al to the total amount of Ni and Co in the sample was 4 wt %.

### [Acid Leaching Step]

Next, the test sample was mixed with a mixed liquid (pH: 0.01) of sulfuric acid (H₂SO₄) (concentration: 2 mol/L) as an acid liquid and hydrogen peroxide (H₂O₂) (concentration: 0.6 mol/L) as a reducing agent. Then, the acid liquid was stirred at a stirring speed of 600 rpm for 6 hours while being maintained at 80° C. After stirring, an acid leaching liquid was filtered, and the obtained acid leaching liquid was analyzed by ICP to measure the substance amount of each of Al, Ni, and Co. As a result of the ICP measurement, the concentration of Ni and Co (sum of Ni and Co) in the acid leaching liquid was 1.0 mol/L.

### [Neutralization Precipitation Step]

The acid leaching liquid obtained above was maintained at 25° C., and while stirring at a stirring speed of 600 rpm, a 10 wt % sodium hydroxide solution was added dropwise to the acid leaching liquid. The dropwise addition of sodium hydroxide was stopped when the pH of the acid leaching liquid reached 5.1. After the dropwise addition was stopped, stirring was continued at a stirring speed of 600 rpm for 10 minutes, and it was confirmed that there was no change in pH. Thereafter, the metal solution and the precipitate were separated as liquid and solid by filtration.

### Example 2

In the neutralization precipitation step, the dropwise addition of sodium hydroxide was stopped when the pH of the acid leaching liquid reached 5.6. Except for this, the procedure was the same as in Example 1.

### Example 3

In the neutralization precipitation step, the dropwise addition of sodium hydroxide was stopped when the pH of the acid leaching liquid reached 6.2. Except for this, the procedure was the same as in Example 1.

### [Residual Rate in Metal Solution in Neutralization Precipitation Step]

The residual rate of valuable metals (Ni and Co) and Al in the metal solution of each Example after the neutralization precipitation step was calculated. Specifically, first, the metal solution was subjected to ICP to measure the substance amount of each of Ni, Co, and Al in the metal solution. Then, based on the following formulas (1) and (2), the Ni/Co residual rate in the metal solution and the Al residual rate in the metal solution were respectively calculated in comparison to the acid leaching liquid (i.e., before the neutralization precipitation step) of each Example. The results are shown in Table 1.

$$Ni / Co residual rate in metal solution ( \% ) = \{ ( Ni substance amount in metal solution + Co substance amount in metal solution ) / ( Ni substance amount in acid leaching liquid + Co substance amount in acid leaching liquid ) \} \times 100 \qquad ( 1 )$$

$$Al residual rate in metal solution ( \% ) = ( Al substance amount in metal solution / Al substance amount in acid leaching liquid ) \times 100 \qquad ( 2 )$$

### [Ni/Co Ratio in Precipitate in Neutralization Precipitation Step]

In addition, the ratio of the amount of valuable metals (Ni and Co) to the amount of Al in the precipitate of each Example after the neutralization precipitation step was calculated. Specifically, first, the precipitate after the neutralization precipitation step was subjected to ICP to measure the substance amount of each of Ni, Co, and Al in the precipitate. Then, based on the following formula (3), the ratio of the substance amount of valuable metals (Ni and Co) in the precipitate of each Example was calculated. The results are shown in Table 1.

$$Ni / Co ratio in precipitate ( \% ) = \{ ( Ni substance amount in precipitate + Co substance amount in precipitate ) / Al substance amount in precipitate \} \times 100 \qquad ( 3 )$$

TABLE 1

| | Neutralization precipitation step | | | |
|---|---|---|---|---|
| | | Ni/Co residual | Al residual | |
| | Precipitation | rate in metal | rate in metal | Ni/Co ratio in |
| | pH | solution (%) | solution (%) | precipitate (%) |
| Example 1 | 5.1 | 99 | 1.5 | 23 |
| Example 2 | 5.6 | 99 | 0.9 | 21 |
| Example 3 | 6.2 | 82 | 0.2 | 450 |

As shown in the results of Table 1, the Al residual rate in the metal solution was 1.5% in Example 1, in which the pH during precipitation was 5.1 in the neutralization precipitation step. This reveals that Al contained in the acid leaching liquid has almost been neutralized and precipitated at the time that the acid leaching liquid is neutralized to a pH of 5.1. A comparison between Examples 1 to 3 shows that the higher the pH during precipitation, the lower the Al residual rate in the metal solution, and that the Al residual rate in the metal solution was the lowest in Example 3, in which the pH during precipitation was 6.2. On the other hand, in Example 3, the Ni/Co residual rate in the metal solution was the lowest, and the Ni/Co ratio in the precipitate was the highest.

### Test Example 2: Consideration of Ammonia Leaching Step

### Example 4

### [Ammonia Leaching Step]

The precipitate obtained in the neutralization precipitation step was subjected to ammonia leaching. Specifically, first, ammonia water with a pH of 11.2 (ammonia concentration in solution: 1.5 wt %) was prepared as an ammonia solution. Then, the precipitate according to Example 1 obtained in the neutralization precipitation step was placed in the ammonia solution. The ammonia solution was stirred at a stirring speed of 600 rpm for 2 hours while being maintained at 80° C. When the pH of the solution was reduced during stirring, an additional ammonia solution with an ammonia concentration of 28 wt % was added to adjust the pH to 11.2. After stirring, the ammonia leaching liquid and the residue were separated as liquid and solid by filtration.

### Example 5

In Example 5, the ammonia leaching step was performed so that the pH of the ammonia solution was 12.1 (ammonia concentration in solution: 10.0 wt %). Except for this, the procedure was the same as in Example 4.

### Example 6

In Example 6, 2 mol/L of ammonium sulfate ((NH₄)₂SO₄) as a pH buffer material was added to ammonia water with a pH of 12.1 (ammonia concentration in solution: 10.0 wt %) as an ammonia solution. In this way, the ammonia leaching step was performed so that the pH of the ammonia solution was 9.6. Except for this, the procedure was the same as in Example 4.

### Examples 7 to 9

In Example 7, the ammonia leaching step was performed using the precipitate according to Example 2. Except for this, the procedure was the same as in Example 4. In Example 8, the ammonia leaching step was performed using the precipitate according to Example 2. Except for this, the procedure was the same as in Example 5. In Example 9, the ammonia leaching step was performed using the precipitate according to Example 2. Except for this, the procedure was the same as in Example 6.

### Examples 10 to 12

In Example 10, the ammonia leaching step was performed using the precipitate according to Example 3. Except for this, the procedure was the same as in Example 4. In Example 11, the ammonia leaching step was performed using the precipitate according to Example 3. Except for this, the procedure was the same as in Example 5. In Example 12, the ammonia leaching step was performed using the precipitate according to Example 3. Except for this, the procedure was the same as in Example 6.

### Example 13

In Example 13, the ammonia leaching step was performed while the ammonia solution was maintained at a temperature of 25° C. Except for this, the procedure was the same as in Example 12.

### [Ni/Co Residual Rate in Residue]

The residual rate of valuable metals (Ni and Co) in the residue of each Example after the ammonia leaching step was calculated. Specifically, first, the residue was subjected to ICP to measure the substance amount of each of Ni, Co, and Al in the residue. Then, based on the following formula (4), the ratio of the substance amount of valuable metals (Ni and Co) in the residue of each Example to the substance amount of Al in the residue was calculated. The results are shown in Table 2.

$$Ni / Co ratio in residue ( \% ) = \{ ( Ni substance amount in residue + Co substance amount in residue ) / Al substance amount in residue \} \times 100 \qquad ( 4 )$$

### [Al Leaching Rate in Ammonia Leaching Liquid]

The Al leaching rate in the ammonia leaching liquid of each Example after the ammonia leaching step was calculated. Specifically, first, the ammonia leaching liquid was subjected to ICP to measure the Al substance amount in the ammonia leaching liquid. Then, based on the following formula (5), the ratio of the Al substance amount in the ammonia leaching liquid to the Al substance amount in the residue of each Example was calculated. The results are shown in Table 2.

$$Al leaching rate in ammonia leaching liquid ( \% ) = ( Al substance amount in ammonia leaching liquid / Al substance amount in residue ) \times 100 \qquad ( 5 )$$

TABLE 2

| | | | Ammonia leaching step | | | | |
|---|---|---|---|---|---|---|---|
| | Neutralization precipitation step | | | | | | Al leaching |
| | | Ni/Co ratio in | pH during | Temperature | Ammonium | Ni/Co ratio in | rate in ammonia |
| | Precipitate | precipitate (%) | leaching | (° C.) | sulfate | residue (%) | leaching liquid (%) |
| Example 4 | Example 1 | 23 | 11.2 | 80 | — | 2.0 | 0.2 |
| Example 5 | | | 12.1 | 80 | — | 0.5 | 0.8 |
| Example 6 | | | 9.6 | 80 | ◯ | 0.1 | 0.0 |
| Example 7 | Example 2 | 21 | 11.2 | 80 | — | 2.0 | 0.2 |
| Example 8 | | | 12.1 | 80 | — | 0.4 | 0.9 |
| Example 9 | | | 9.6 | 80 | ◯ | 0.1 | 0.0 |
| Example 10 | Example 3 | 450 | 11.2 | 80 | — | 2.7 | 0.1 |
| Example 11 | | | 12.1 | 80 | — | 1.0 | 0.6 |
| Example 12 | | | 9.6 | 80 | ◯ | 0.5 | 0.0 |
| Example 13 | | | 9.6 | 25 | ◯ | 0.9 | 0.0 |

As shown in the results of Table 2, in Example 4, in which the pH of the ammonia solution was 11.2, the Ni/Co ratio in the residue was significantly lower than the Ni/Co ratio in the precipitate (i.e., before the ammonia leaching step). Further, the Al leaching rate in the ammonia leaching liquid of Example 4 was 0.2%. This reveals that Ni and Co in the precipitate are suitably selectively recovered by ammonia leaching in Example 4. On the other hand, as shown in Example 5, when the pH of the ammonia solution was 12.1, ammonia leaching was effective in recovering Ni and Co in the precipitate, whereas the Al leaching rate in the ammonia leaching liquid was higher than that of Example 4. Furthermore, a comparison between Examples 4 to 6 shows that in Example 6, in which the ammonia solution contained ammonium sulfate, the Al leaching rate in the ammonia leaching liquid was the lowest, and the Ni/Co ratio in the residue was also the lowest.

As shown in the results of Examples 7 to 9 and 10 to 12, it is revealed that similar results as in Examples 4 to 6 can be obtained even when using the precipitates according to Examples 2 and 3, whose pHs are different during neutralization and precipitation. The results of Example 13 reveal that Ni and Co can be selectively recovered from the precipitate even when the temperature of the ammonia solution is 25° C., and that the leaching of Al into the ammonia leaching liquid can be suppressed. A comparison between Examples 12 and 13 shows that the Ni/Co ratio in the residue was lower in Example 12, in which the temperature of the ammonia solution was 80° C.

The technology disclosed herein is described in detailed above; however, these are merely examples and do not limit the scope of the claims. The technology described in the claims includes various modifications and changes to the specific examples illustrated above. That is, the technology disclosed herein includes the forms described in Items 1 to 7 below.

### <Item 1>

A method for producing a battery material, comprising:
a preparation step of preparing a recovery target comprising at least one of Ni and Co; an acid leaching step of immersing the recovery target in an acid liquid to obtain an acid leaching liquid;
a neutralization precipitation step of mixing the acid leaching liquid and a neutralizer to obtain a precipitate;
a solid-liquid separation step of separating the precipitate into solid and liquid; and
an ammonia leaching step of immersing the separated precipitate in an ammonia solution containing ammonium ions to obtain an ammonia leaching liquid containing at least one of the Ni and the Co.

### <Item 2>

The method for producing a battery material according to Item 1, wherein the ammonia leaching step is performed while the ammonia solution is adjusted to a pH of 9.0 to 11.5.

### <Item 3>

The method for producing a battery material according to Item 1 or 2, wherein the ammonia solution comprises at least one member selected from the group consisting of ammonium sulfate, ammonium chloride, and ammonium acetate.

### <Item 4>

The method for producing a battery material according to any one of Items 1 to 3, further comprising a precursor production step of producing a positive electrode active material precursor using the ammonia leaching liquid obtained in the ammonia leaching step.

### <Item 5>

The method for producing a battery material according to any one of Items 1 to 4, wherein the ammonia leaching step is performed while the ammonia solution is adjusted to a temperature of 25 to 100° C.

### <Item 6>

The method for producing a battery material according to any one of Items 1 to 5, wherein the acid leaching liquid is neutralized to a pH of 5.0 to 6.5 in the neutralization precipitation step.

### <Item 7>

The method for producing a battery material according to any one of Items 1 to 6, wherein the recovery target comprises at least one member selected from the group consisting of a lithium nickel composite oxide, a lithium cobalt composite oxide, a lithium nickel manganese composite oxide, a lithium manganese cobalt composite oxide, a lithium nickel cobalt composite oxide, and a lithium nickel manganese cobalt composite oxide.

What is claimed is:

1. A method for producing a battery material, comprising:
a preparation step of preparing a recovery target comprising at least one of Ni and Co;
an acid leaching step of immersing the recovery target in an acid liquid to obtain an acid leaching liquid;
a neutralization precipitation step of mixing the acid leaching liquid and a neutralizer to obtain a precipitate;
a solid-liquid separation step of separating the precipitate into solid and liquid; and
an ammonia leaching step of immersing the separated precipitate in an ammonia solution containing ammonium ions to obtain an ammonia leaching liquid containing at least one of the Ni and the Co.

2. The method for producing a battery material according to claim 1, wherein the ammonia leaching step is performed while the ammonia solution is adjusted to a pH of 9.0 to 11.5.

3. The method for producing a battery material according to claim 1, wherein the ammonia solution comprises at least one member selected from the group consisting of ammonium sulfate, ammonium chloride, and ammonium acetate.

4. The method for producing a battery material according to claim 1, further comprising a precursor production step of producing a positive electrode active material precursor using the ammonia leaching liquid obtained in the ammonia leaching step.

5. The method for producing a battery material according to claim 1, wherein the ammonia leaching step is performed while the ammonia solution is adjusted to a temperature of 25 to 100° C.

6. The method for producing a battery material according to claim 1, wherein the acid leaching liquid is neutralized to a pH of 5.0 to 6.5 in the neutralization precipitation step.

7. The method for producing a battery material according to claim 1, wherein the recovery target comprises at least one member selected from the group consisting of a lithium nickel composite oxide, a lithium cobalt composite oxide, a lithium nickel manganese composite oxide, a lithium manganese cobalt composite oxide, a lithium nickel cobalt composite oxide, and a lithium nickel manganese cobalt composite oxide.
